(19) United States
(12) Patent Application Publication
(10) Pub. No.: US 2017/0136449 A1
(43) Pub. Date: May 18, 2017

(54) NOVEL SUPPORTED ANTHRAQUINONIC CATALYSTS AND USES OF SAME FOR KRAFT COOKING

(71) Applicants: UNIVERSITÉ DE BORDEAUX, BORDEAUX (FR); INSTITUTE POLYTECHNIQUE DE BORDEAUX, TALENCE (FR); Centre national de la recherche scientifique, PARIS (FR); SMURFIT KAPPA CELLOLOSE DU PIN, BIGANOS (FR)

(72) Inventors: Valentina-Mihaela ROUSSEAU-POPA, TALENCE (FR); Valérie HEROGUEZ, MERIGNAC (FR); Frédérique PICHAVANT, GRADIGNAN (FR); Christian GARDRAT, GRADIGNAN (FR); Alain CASTELLAN, LEOGNAN (FR); Stéphane GRELIER, Parentis-en born (FR)

(21) Appl. No.: 15/323,355

(22) PCT Filed: Jul. 2, 2015
(86) PCT No.: PCT/EP2015/065068

§ 371 Date: Dec. 30, 2016

(30) Foreign Application Priority Data
Jul. 3, 2014 (FR) 1456394

(51) Int. Cl. B01J 31/00; D21C 3/22; B01J 31/06; D21C 3/02

(52) U.S. Cl. CPC B01J 31/006; D21C 3/022; D21C 3/222; B01J 31/06

(57) ABSTRACT

The present invention relates to a supported anthraquinonic catalyst which may be obtained by radical polymerization of a reaction mixture comprising styrene; at least one initiator generating free radicals; at least one cross-linking agent which is at least difunctional, at least one pore-forming agent; and at least one anthraquinonic styrenic monomer of formula (I)

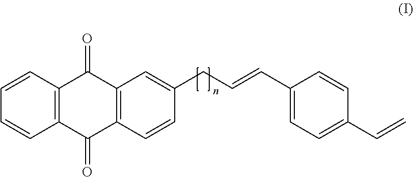

wherein n is an integer varying from 1 to 5.

The object of the present invention is novel supported anthraquinonic catalysts, their preparation methods, and their uses notably for kraft cooking of wood shavings.

The economical impact of the forest—wood—paper segment is important, notably in France in the Aquitaine region. Within this segment, the paper-making industry, and more specifically the industries manufacturing cellulosic pulps form a primordial economical sector.

The greatest production of pulps uses the kraft process as a method for extracting cellulose. Based on the use of a solution of soda and sodium sulfide, the kraft process is today the universal process for manufacturing chemical paper pulps. The latter has many advantages such as a low content of residual lignin and good mechanical and physico-chemical properties of the fibers. This method is also self-sufficient in energy and allows a reduction in the consumption of reagents with regeneration of the inorganic reagents.

In spite of these advantages, the kraft process has non-negligible drawbacks: low yields (about 45%) since a portion of the hemicelluloses and of cellulose is degraded; formation of volatile sulfur-containing derivatives, responsible for odor nuisances . . . .

Environmental constraints impose to the paper-making industry to go towards a cleaner chemistry and safer but which remains competitive (depletion of forest resources, harmful pollutions for humans and the environment). Efforts which are included in a sustainable development have already been achieved such as plantation of forests, recycling of papers and card boards, resorting to the biomass and the concept of a bio-refinery, improvement of the processes, . . . .

In particular, the use of anthraquinone in a catalytic amount has prove to be very performing for improving the soda and kraft cooking operations. It gives the possibility of both improving the yield of cellulosic pulp and of accelerating delignification. In spite of this efficiency, the non-regeneration of anthraquinone and its too high cost are, for the moment unfavorable for a generalized industrial use.

Therefore there exists a need for having efficient catalysts for the kraft cooking of wood, which may be recycled.

The aim of the present invention is therefore to provide novel anthraquinonic catalysts notably intended for kraft cooking of wood.

The aim of the present invention is also to provide novel entirely recyclable anthraquinonic catalysts.

The aim of the present invention is also to provide efficient anthraquinonic catalysts for the kraft cooking of wood and giving the possibility of improving the yield of this process.

Thus, the present invention relates to a supported anthraquinonic catalyst, comprising a polymeric support containing at the surface at least one anthraquinone unit, said supported anthraquinonic catalyst being capable of being obtained by radical polymerization of a reaction mixture comprising:
styrene;
at least one initiator generating free radicals;
at least one at least difunctional cross-linking agent, selected from the group consisting of: divinylbenzene, ethylene glycol dimethacrylate, di(ethylene glycol) dimethacrylate, compounds comprising an alkyl chain, interrupted by one or several groups —((CH₂)ₖO)ₘ with 2≦k≦5, 1≦m≦3, substituted in positions α or ω with at least one acrylate, methacrylate, vinyl or styrene function, and mixtures thereof;
at least one pore-forming agent; and
at least one anthraquinonic styrenic monomer of formula (I)

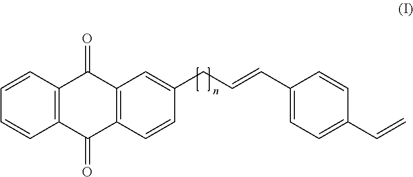

wherein n is an integer varying from 1 to 5.

The present invention also relates to a method for preparing a supported anthraquinonic catalyst as defined above, by radical polymerization of a reaction mixture comprising:
styrene;
at least one initiator generating free radicals;
at least one cross-linking agent which is at least difunctional as defined above;
at least one pore-forming agent; and
at least one anthraquinonic styrenic monomer of formula (I) as defined above.

Radical Polymerization

The anthraquinonic catalyst according to the invention is obtained according to a method well known to one skilled in the art, radical polymerization. This method is carried out by growth and by propagation of macroradicals. These macroradicals, provided with a very short lifetime, recombine in an irreversible way by coupling or disproportionation.

Such a method consists in a chain polymerization which involves as an active species, radicals. It comprises initiation, propagation, termination and chain transfer reactions.

The first step of such a method consists in generating so called primary radicals by means of a radical initiator as defined hereafter.

According to an embodiment, the method used may be a so called <<controlled>> or <<live >> radical polymerization, which is also a process well known to one skilled in the art. From among these well known processes of controlled radical polymerization, mention may for example be made of the RAFT (chain transfer by reversible addition-fragmentation) or NMRP (controlled radical polymerization by nitroxides) processes.

According to an embodiment, the polymerization is carried out in a mold by simple heating. The reaction mixture is as defined above and comprises one or several monomers including a cross-linking agent, one or several pore-forming agents and an initiator. At the end of the polymerization, the catalyst is obtained as a monolith which is purified with a more volatile solvent in order to remove the heavier pore-forming agents and the unreacted reagents.

As monomers used for preparing the catalysts, styrene is notably used.

According to an embodiment, the aforementioned reaction mixture comprises from 10% to 30% by weight of styrene based on the total weight of the reaction mixture. Preferably, the weight content of styrene in the reaction mixture is comprised between 15% and 25%, and preferably between 20% and 25%.

Initiator

As indicated above, the polymerization method is initiated by adding a polymerization initiator. These initiators are designated as <<initiators generating free radicals>>.

From among these initiators, mention may be made of thermal, redox initiators or further initiators for controlled radical polymerization.

Thermal initiators are selected from among the initiators generating radicals by thermal decomposition. Examples comprise organic peresters (t-butylperoxypivalate, t-amylperoxypivalate, t-butylperoxy-2-ethylhexanoate, etc); organic compounds of the azo type, for example azo-bis-amidino-propane hydrochloride, azo-bis-isobutyronitrile, azo-bis-2,4-dimethylvaleronitrile, etc); inorganic and organic peroxides, for example hydrogen peroxide, benzoyl peroxide and butyl peroxide.

According to an advantageous embodiment of the invention, the initiator used is an organic peroxide or an organic compound of the azo type. Such an initiator is preferably benzoyl peroxide or azobisisobutyronitrile (AIBN), and is preferentially AIBN.

From among the initiators, mention may also be made of redox initiators, for which the production of radicals results from an oxidation-reduction reaction. Mention may notably be made of systems of redox initiators, such as those comprising oxidizing agents, such as persulfates (notably ammonium persulfates or alkaline metal persulfates, etc); chlorates and bromates (including inorganic or organic chlorates and/or bromates); reducing agents such as sulfites and bisulfites (including inorganic and/or organic sulfites or bisulfites); oxalic acid and ascorbic acid as well as mixtures of two or more of these compounds.

According to an embodiment, the aforementioned reaction mixture comprises from 0.1% to 5% by weight of an initiator based on the total weight of reaction mixture. Preferably, the initiator weight content in the reaction mixture is comprised between 0.5% and 3%.

Cross-Linking Agent

As indicated above, the reaction medium also comprises at least one cross-linking agent.

This cross-linking agent is at least a difunctional agent.

According to an embodiment, this cross-linking agent is a compound comprising an alkyl chain interrupted with one or several groups —((CH₂)ₖO)ₘ with 2≦k≦5, 1≦m≦3, said group(s) being substituted in position a or w with at least one acrylate, methacrylate, vinyl or styrenic function.

A cross-linking agent according to the invention for example comprises at least two functions notably selected independently from among acrylate, methacrylate, vinyl and styrenic functions.

In particular, the cross-linking agent according to the invention comprises at least two vinyl functions or at least two (meth)acrylate functions.

According to an embodiment, the cross-linking agent is a cross-linking agent selected from the group consisting of divinylbenzene, ethylene glycol dimethacrylate, di(ethylene glycol) dimethacrylate, and mixtures thereof.

Preferably, the cross-linking agent according to the invention is di(ethylene glycol) dimethacrylate.

According to an embodiment, the aforementioned reaction mixture comprises from 10% to 30% by weight of a cross-linking agent based on the total weight of the reaction mixture. Preferably, the weight content of a cross-linking agent in the reaction mixture is comprised between 12% and 25%, and preferably between 15% and 20%.

Pore-Forming Agent

The reaction mixture also comprises at least one pore-forming agent, and preferably at least two pore-forming agents.

According to an embodiment, the pore-forming agent is selected from compounds in which the catalyst is insoluble and in which the anthraquinonic styrenic monomers of formula (I) are soluble at the temperature of the method of the invention.

Pore-forming agents do not react during the polymerization but participate in the formation of pores. They remain trapped in the pores, surrounded by the polymeric mass until the end of the reaction. Their volume fraction is related to the porosity.

According to an embodiment, the boiling point of these compounds is greater than the polymerization temperature.

According to an embodiment, the pore-forming agent is selected from the group consisting of toluene, long chain alcohols comprising at least 10 carbon atoms, and preferably 10 to 20 carbon atoms, long chain alkanes comprising at least 10 carbon atoms, and preferably from 10 to 20 carbon atoms, ethylene glycol oligomers and mixtures thereof.

The term of <<ethylene glycol oligomer>> designates within the scope of the present invention, a compound consisting of at least two ethylene glycol units. Such a compound may for example be represented by the formula H—(OCH₂CH₂)ᵢ—OH, i being an integer greater than or equal to 2, and preferably less than 4.

Preferably, the supported anthraquinonic catalyst according to the invention is obtained by the aforementioned method comprising the application of a mixture of at least two pore-forming agents.

According to an embodiment, the pore-forming agent is a mixture of at least two compounds selected from the group consisting of toluene, alcohols with a long carbonaceous chain comprising at least 10 carbon atoms, alkanes with a long chain of at least 10 carbon atoms and ethylene glycol oligomers.

According to an embodiment, the reaction mixture comprises dodecanol and/or toluene as a pore-forming agent. Preferably, the pore-forming agent is a mixture of dodecanol and of toluene.

According to an embodiment, the aforementioned reaction mixture comprises from 10% to 60% by weight of pore-forming agent(s) based on the total weight of the reaction mixture. Preferably, the weight content of pore-forming agent(s) in the reaction mixture is comprised between 30% and 60%, and preferably between 50% and 60%.

Monomer of Formula (I)

The reaction mixture according to the invention also comprises at least one monomer of formula (I) as defined above.

This monomer is a monomer from the family of anthraquinones.

Preferably, in formula (I), n is equal to 2.

According to an embodiment, the aforementioned reaction mixture comprises less than 10% by weight of an anthraquinonic styrenic monomer of formula (I). Preferably, the weight content of anthraquinonic styrenic monomer of formula (I) in the reaction mixture is comprised between 0.01% and 10%, and preferably between 5% and 10%.

According to a preferred embodiment, the aforementioned reaction mixture comprises:
from 10% to 30% by weight of styrene based on the total weight of the reaction mixture;
from 0.1% to 5% by weight of an initiator, notably AIBN, based on the total weight of reaction mixture;
from 10% to 30% by weight of a cross-linking agent, notably di(ethylene glycol) dimethacrylate, based on the total weight of reaction mixture;
from 10% to 60% by weight of pore-forming agent(s), preferably a mixture of dodecanol and toluene, based on the total weight of reaction mixture; and
at least 10% by weight of anthraquinonic styrenic monomer of formula (I), notably wherein n=2.

Catalyst

The catalysts according to the invention are supported catalysts which comprise a polymeric support containing at the surface at least one anthraquinone unit. This anthraquinone unit stems from the monomer of the aforementioned formula (I).

These catalysts therefore comprise a support of a polymeric nature on which are grafted anthraquinone units.

According to an embodiment, the supported anthraquinonic catalysts according to the invention comprise from 5% to 20%, preferably from 8% to 11%, by weight of anthraquinone based on the total weight of supported anthraquinone catalyst.

The catalysts according to the invention are notably in the form of monoliths.

Monoliths are porous and solid materials formed in a single piece. According to the invention, they are of a polymeric (organic) nature.

The catalysts according to the invention may also be designated as <<macroporous rigid organic monoliths>>, or as monolithic anthraquinonic catalysts or monolithic catalysts.

Monolithic catalysts according to the invention differ from the catalysts usually used in an emulsion, i.e. as particles. The catalysts according to the invention are not in the form of particles but as monoliths as indicated above.

The main feature of these monoliths is their porosity which persists even in the dry condition. They consist of several grains (microspheres) aggregated as clusters (grain aggregates) and have pores for which the size strongly depends on the composition of the polymerization mixture (reaction mixture). The <<pores >> are irregular empty spaces formed between and in the clusters. They are interconnected and they form channels which allows the monolith to be penetrated in its depth by solutes and solvents.

The mechanical properties of these materials are related to the very strong cross-linking of their lattice.

The catalysts obtained according to the invention are therefore porous materials consisting of pores with variable shapes and sizes. Pores are classified according to their size in three categories:
micropores with pore diameters (dₚₒᵣₑₛ) of less than 2 nm,
mesopores with dₚₒᵣₑₛ comprised between 2 nm and 50 nm,
macropores with dₚₒᵣₑₛ greater than 50 nm.

According to an embodiment, the catalyst of the invention is a mesoporous monolith.

The porous structure of the monoliths may be evaluated by using several techniques from among which:

1) nitrogen adsorption and desorption measurements (BET) which allow determination of the specific surface area,

2) porosimetry measurements with mercury intrusion (PIM) which allows determination of the size distribution of the pores,

3) scanning electron microscopy (SEM), transmission electron microscopy (TEM) and atomic force microscopy (AFM) which give the possibility of viewing the morphology of the monoliths,

4) inverse steric exclusion chromatography (ISEC) used for determining the porous structure by a mathematical calculation from elution times of a series of known molar mass standards through a monolithic column considered as a stationary phase. The ISEC measurements show the porosity of the monoliths in the humid condition while all the other techniques characterize the porosity of the dry material and assume that their porosity does not change when they are in presence of a liquid phase. Moreover, in the case of nitrogen adsorption and desorption measurements, the aspect of the adsorption isotherms give indications on the type of porosity of the material: macro-, meso- or micro-porous.

According to the invention, the average diameter of the pores of the catalysts in the dry condition may vary from 5 nm to 10 nm as measured by the BET method (as detailed in the experimental part hereafter) and from 50 nm to 300 nm as measured by mercury porosity (as detailed in the experimental part hereafter).

The monolithic catalysts according to the invention assume the shape of the polymerization reactor (tube or column), the latter may consist of different materials: glass, steel, silicone, synthetic polymers, . . . .

According to the nature of the mold used for preparing these catalysts, they may have several geometrical shapes, such as cylinders or beads. According to a preferred embodiment, the catalysts of the invention have a cylindrical shape.

The diameter of the synthesized monoliths may be comprised between 10 micrometers for example for chromatographic columns and 25 millimeters or even up to 200 millimeters for example for reaction media.

According to an embodiment, the supported anthraquinonic catalyst has a specific surface area, determined by the BET method, of more than or equal to 20 m²/g, and preferably comprised between 20 and 200 m²/g.

The surface of the pores associated with that of the grains per unit mass represents the specific surface area of the porous material. The main contribution to the specific surface area stems from micropores and then mesopores. The more there are micropores, the greater is the specific surface area. Macropores as for them have a negligible contribution to the specific surface area but allow the liquid to circulate inside the monolith at a relatively low pressure. These are the ones which will give the possibility of supporting the hydraulic or electro-osmotic flow rate in the monolith and allow convective mass transfer.

The supported anthraquinonic catalysts according to the invention have interesting mechanical properties. In particular, the Young modules of these catalysts may be comprised between 100 MPa and 400 MPa.

The Young modulus characterizing the elastic behavior of the material was estimated by considering the monolith in a rectangular form with width and height equal to 10 mm and with length between supports of 35 mm.

The catalysts according to the invention also have the advantage of being able to be recycled, i.e. they may be used at least once more after a first use, and this while retaining their catalytic properties. They may advantageously be reused several times after their first use. Preferably, they are recycled, i.e. reused, for at least 4, or even 5, or even 6 times.

This recyclability nature is particularly advantageous notably as compared with conventional catalysts as particles.

Applications

The present invention also relates to the use of the supported anthraquinonic catalyst as defined above, for catalyzing kraft or alkaline cooking of wood or of lignocellulosic biomass.

Alkaline cooking of wood (or soda process) is the most simple alkaline cooking process, in which the wood is processed with an aqueous solution of sodium hydroxide at a temperature comprised between 150° C. and 170° C. At the end of cooking, the black liquor containing the organic and inorganic dissolved derivatives is concentrated by evaporation and burnt. The obtained residue is sodium carbonate which will be transformed into soda by caustification with calcium hydroxide. This method gives the possibility of isolating the cellulose fibers after removing a large portion of the lignin and of the hemicelluloses.

The kraft process, also generally called a sulfate process, is a method in which the sodium sulfate is used as a chemical in the regeneration of the cooking liquor. This method is today used in most paper-making industries which are easily recognized by the odor given by the volatile sulfur-containing compounds formed during the cooking.

Typically, the wood shavings are treated at a temperature of 160° C.-180° C. (pressure 8-9 bars) for 2 to 3 hours in a chemical reactor called a digester in the presence of an aqueous solution of soda (NaOH) and of sodium sulfide (Na₂S) called <<white liquor>>.

The liquor recovered at the end of the cooking operation called <<black liquor >> mainly contains inorganic salts and organic compounds consisting of lignin and of polysaccharides obtained by degradation but also small amounts of extractibles. During this cooking, the lignin is dissolved releasing the cellulosic fibers.

The present invention also relates to a method for preparing a cellulosic pulp, comprising a kraft or alkaline cooking step of wood shavings or of lignocellulosic biomass at a temperature comprised between 130° C. and 180° C. for a period from 30 minutes to 120 minutes, in the presence of water, of supported anthraquinonic catalyst as defined above, and of an aqueous solution of soda and/or sodium sulfide.

The invention therefore also relates to the application of the soda method or the kraft process mentioned above with the catalyst according to the invention.

This method consists of putting into presence wood shavings or lignocellulosic biomass with water, said catalyst and an aqueous solution of soda and/or sodium sulfide (according to the applied technology).

According to an embodiment, the weight content of active alkali, i.e. the weight content of soda and of sodium sulfide, expressed in equivalent grams of NaOH or Na₂O, is comprise between 9% and 26% based on the total weight of dry wood (wood shavings or lignocellulosic biomass).

According to an embodiment, the sulfidity S, corresponding to the existing sulfur level defined as the ratio between the sodium sulfide and the active alkali, ranges from 25% to 35%.

According to an embodiment, the dilution factor ranges from 3 to 4.5 (the dilution factor represents the ratio between the total amount of water (sum of the water contained in the wood plus the volume of white liquor) and the amount of dry wood).

According to an embodiment, the anthraquinonic catalyst content according to the invention is less than 0.5% by weight based on the dry wood weight used.

The use of the catalysts according to the invention is particularly advantageous within the scope of the kraft process since the yields are improved as compared with a kraft process with anthraquinonic catalysts according to the state of the art.

Further, these catalysts give the possibility of using a lesser amount of reagents (soda and sodium sulfide) as compared with kraft processes with anthraquinonic catalysts according to the state of the art.

The present invention also relates to a method for preparing hydrogen peroxide, comprising a step for hydrogenation of the supported anthraquinonic catalyst as defined above, followed by an oxidation step with oxygen from air.

### EXAMPLES

The reagents used are available commercially at Sigma-Aldrich.

### Example 1: Preparation of an Anthraquinonic Styrenic Monomer of Formula (I)

This example relates to the preparation of the monomer of the following formula:

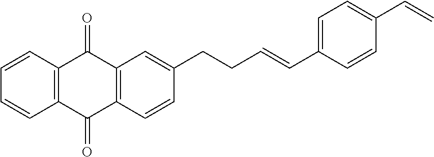 [SMILES: C=Cc1ccc(/C=C/CCc2ccc3c(c2)C(=O)c2ccccc2C3=O)cc1]

The synthesis of this monomer, designated hereafter by AQwittig, is carried out in four steps, according to the scheme below:

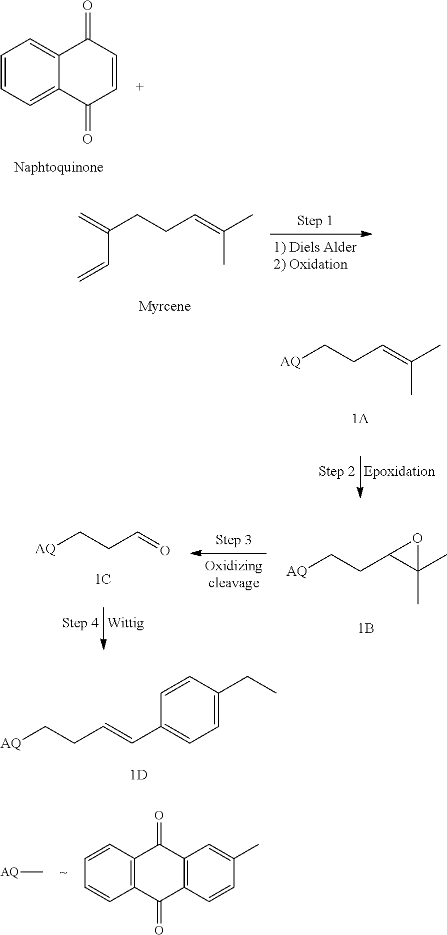

The first step is a Diels-Alder reaction between myrcene and naphthoquinone which leads to the formation of 2-(4-methyl-pent-3-enyl)-anthraquinone, 1A. This product was synthesized by the company “Dérivés Résiniques et Terpéniques”.

Myrcene and naphthoquinone are solubilized in toluene or a mixture of toluene and butanol. The solution is heated to 90° C. until consumption of the reagents. The aromatization is achieved subsequently by adding a solution of sodium or potassium hydroxide at 50% while maintaining the mixture at 70° C. while bubbling oxygen. After evaporation of the solvents, the derivative 1A is obtained with a yield of more than 90%.

The synthesis procedure was described by Cazeils (<<Synthèse de nouveaux catalyseurs de cuisson papetière. Etude de leurs mécanismes d'action>>. Thesis No. 3477, University of Bordeaux 1, 2007). The second step of the synthesis of the monomer is epoxidation of the double bond of the side chain of anthraquinone followed by oxidizing cleavage of the epoxide formed into an aldehyde (electrophilic opening of the epoxide). The last step is the Wittig reaction of the aldehyde with the 4-vinylbenzyltriphenylphosphonium chloride in the presence of a phase transfer agent.

The second step consists of synthesizing 2-[2-3,3-dimethyl-oxiranyl)-ethyl]-anthraquinone (1B).

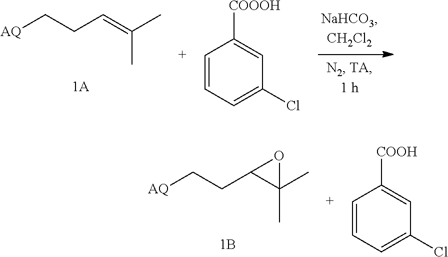

| | | m (g) or | | |
|---|---|---|---|---|
| Reagents | M (g mol⁻¹) | V (mL) | | n (mmol) |
| 1A | 290 | 14 | g | 48.24 |
| m-CPBA 76% | 172 | 12.04 | g | 70 |
| NaHCO₃ | 84 | 4.46 | g | 53.1 |
| CH₂Cl₂ | | 500 | mL | |

In a three-neck flask of one litre provided with a coolant, with a dinitrogen inlet and a magnetized bar, the compound 1A in solution in CH₂Cl₂, meta-chloroperbenzoic acid (m-CPBA) and sodium hydrogen carbonate are introduced and intensively stirred at room temperature (RT) for one hour under a dinitrogen atmosphere. The organic phase is extracted with CH₂Cl₂, washed with an aqueous solution of Na₂S₂O₃ until neutrality, and then dried on sodium sulfate, filtered and evaporated. The compound 1B is obtained as a yellow solid (13.2 g, 43 mmol) with a yield of 94%. It is used without any purification in the next step.

The third step consists of synthesizing 3-(9,10-Dioxo-9,10-dihydro-anthracen-2yl)-propion-aldehyde (1C).

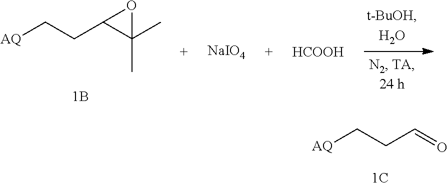

| | | m (g) or | | |
|---|---|---|---|---|
| Reagents | M (g mol⁻¹) | V (mL) | | n (mmol) |
| 1B | 306 | 6.9 | g | 22.55 |
| NaIO₄ | 214 | 14.5 | g | 67.76 |
| t-Bu-OH | | 300 | mL | |
| HCOOH | | 25 | mL | |
| H₂O | | 150 | mL | |

In a three-neck flask of one litre provided with a coolant and with a magnetized bar, the compound 1B, sodium periodate, tertio-butanol, formic acid and distilled water are introduced and intensively stirred at room temperature for 24 hours under a dinitrogen atmosphere. The organic phase is extracted with ethyl acetate, washed with an aqueous solution of sodium carbonate until neutrality, and then dried on sodium sulfate, filtered and evaporated. The compound 1C is obtained as a pale yellow solid (5.55 g, 21.02 mmol) with a yield of 93%. It is used without any purification in the next step.

The method further comprises an intermediate step consisting of synthesizing 4-vinyl-benzyl-triphenyl-phosphonium chloride (1E).

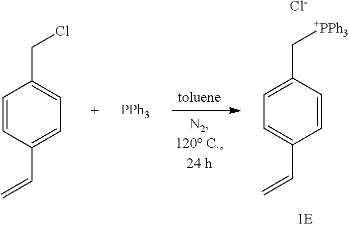

| | | m (g) or | | |
|---|---|---|---|---|
| Reagents | M (g mol⁻¹) | V (mL) | | n (mmol) |
| p-chloromethylstyrene | 152 | 5 | g | 32.89 |
| Ph₃P | 262 | 8.62 | g | 32.89 |
| Toluene | | 50 | mL | |

In a three-neck flask of 100 mL provided with a coolant, a dinitrogen inlet and a magnetized bar, p-chloromethylstyrene in solution in toluene and triphenylphosphine are introduced and intensively stirred with reflux of the solvent for 20 hours. The formed white precipitate is filtered and dried in vacuo in the presence of P₂O₅. The compound 1E is obtained as a white solid (12.39 g, 29.93 mmol) with a yield of 91%. It is used without any purification in the next step.

The last step of the method is the synthesis of 2-[4-(4-vinyl-phenyl)-but-3-enyl]-anthraquinone (1D).

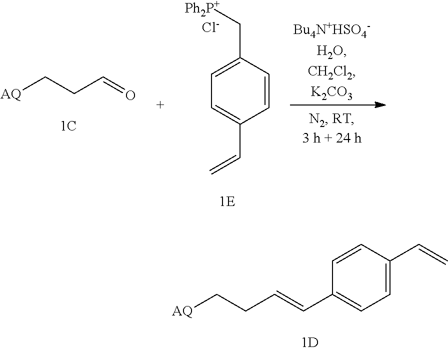

| | | m (g) or | | |
|---|---|---|---|---|
| Reagents | M (g mol⁻¹) | V (mL) | | n (mmol) |
| 1C | 264 | 0.2 | g | 0.757 |
| 1E | 414 | 0.314 | g | 0.757 |
| K₂CO₃ | 138 | 0.157 | g | 1.14 |
| Bu₄N⁺HSO₄⁻ | | Cat. | | |
| H₂O | | 10 | mL | |
| CH₂Cl₂ | | 10 | mL | |

In a three-neck flask provided with a coolant and a magnetized bar, the salt 1E and an aqueous solution of potassium carbonate are introduced and intensively stirred at room temperature for 3 h. And then the compound 1C solubilized in dichloromethane and the phase transfer catalyst, Bu₄N⁺HSO₄⁻, are added; the reaction mixture is intensively stirred at room temperature for 24 hours. The organic phase is extracted with CH₂Cl₂, washed with an aqueous solution of 3% hydrochloric acid until neutrality, and then dried on sodium sulfate, filtered and evaporated. After purification by chromatography on a silica column (eluant CH₂Cl₂), the compound 1D is obtained pure (TLC) as a yellow solid (225 mg, 0.621 mmol) with a yield of 82%.

### Example 2: Preparation of a Supported Anthraquinonic Catalyst

The general scheme of the polymerization reaction for the synthesis of anthraquinonic catalysts according to the invention (monoliths) is illustrated hereafter. The monolithic supports are prepared in glass tubes of variable dimensions (diameter×height=6×40 mm or 10×50 mm).

The table hereafter indicates the amounts of the reagents used for the synthesis of the monoliths St-DVB-AQ of diameter 10 mm according to this example (monolith with divinylbenzene as a cross-linking agent).

| | | m (g) or | | | |
|---|---|---|---|---|---|
| Reagents | M (g mol⁻¹) | V (mL) | | n (mmol) | ρ (g/cm³) |
| AIBN | 164 | 0.026 | g | 0.16 | — |
| AQwittig | 364 | 0.262 | g | 0.72 | — |
| Styrene | 172 | 0.96 | mL | 5.12 | 0.914 |
| DVB (cross- | 104 | 0.64 | mL | 5.58 | 0.909 |
| linking agent) | | | | | |
| Dodecanol | 186 | 2 | mL | 8.98 | 0.833 |
| Toluene | 92 | 0.4 | mL | 3.8 | 0.867 |

The reaction mixture consisting of styrene, cross-linking agent (DVB, EGDMA or DEGMDA), of toluene, of dodecanol, of AQwittig and AIBN (purified in ethanol at 50° C. and recrystallized at 0° C.) is introduced into a tube and hermetically closed by a septum. As the free space in the tube is too small relatively to the gas volume released by the initiator decomposition, it is necessary to add more volume by means of a thin rubber balloon and of a needle which pierces the septum. The reaction medium is homogenized with ultrasonic waves at 50° C. (10 minutes) and degassed by bubbling of nitrogen (10 minutes) in order to remove the dioxygen which inhibits polymerization. The medium is drawn in vacuo and then immersed in an oil bath brought to 70° C. for 24 hours. After polymerization, the monolith is extracted with precaution from the tube contacted with liquid nitrogen and then washed with 700 mL of THF on the soxhlet for about 8 hours in order to remove the pore-forming agents and the monomers which are unreacted. After purification, it is dried in vacuo at 200° C. for 12 hours. The synthesis yield is determined by an indirect method by UV-Visible light spectrometry. The extraction solvent is concentrated for assaying therein, by UV spectrometry, the AQwittig monomer being unreacted in order to determine the AQ functionality of the monolith. The monolith is analyzed in UV, GC, SEM, TEM and PIM.

AIBN is purified by crystallization from ethanol. After dissolution of 5 g of AIBN in 50 mL of ethanol at 50° C., the solution is immediately filtered and the filtrate is cooled to 0° C. The AIBN rapidly crystallizes and the crystals obtained by filtration are dried in vacuo at room temperature and kept in a bottle away from light.

The detailed example above relates to the preparation of monoliths from divinylbenzene as a cross-linking agent but was also applied identically with the cross-linking agents EGDMA or DEGDMA, and this by using the same amounts of reagents as a number of moles.

### Example 3: Assay

As indicated in Example 2, the extraction solvent is concentrated for assaying therein, by UV spectrometry, the AQwittig monomer being unreacted in order to determine the anthraquinone functionality (AQ) of the monolith.

The assay of grafted AQ is carried out by indirect dosage by evaluating the amount of AQ which is unreacted. AQwittig has a characteristic band at 327 nm which gives the possibility of inferring after calibration the concentration of non-grafted AQ. The grafted AQwittig amount is the difference between the initial amount and the assayed amount.

UV-Vis Spectrometry: Dosage of the AQwittig Monomer

The UV-Visible dosages are carried out with a Perkin Elmer Lambda 18 apparatus.

The grafted anthraquinone is dosed by UV-Visible absorption in the following washing mixture: the THF solvent used for purifying the monoliths, diluted in dichloromethane. After having determined absorbance at 327 nm of the solution, the amount of AQ is determined on the basis of a calibration carried out beforehand with AQwittig solutions of known concentrations. The linearity of the calibration gives the possibility of applying Beer-Lambert's law:

A₃₂₇=ε₃₂₇·l·C

wherein l is the length of the optical path (the thickness of the quartz tank is 1 cm), £₃₂₇ is the molar extinction coefficient at 327 nm and at 20° C. determined by linear regression from the calibration straight line (£₃₂₇ of 57,000 L·mol⁻¹·cm⁻¹) and C is the AQwittig concentration (in mM) (y=0.57×+0.02).

Beer-Lambert's law gives the possibility of determining the concentration of AQwittig equivalent in the washing mixture.

The gravimetric yield (Y) of AQwittig is determined by making the ratio between the grafted mass and the initial introduced mass. The grafted AQ level (T_{AQ}) is determined after having calculated the remaining mass (mᵣ) of AQwittig according to the following equations:

$${T}_{AQ} = \frac{{m}_{initiale} - {m}_{r}}{{m}_{monolithes}} \cdot \frac{{M}_{AQ}}{{M}_{AQwittig}} \cdot 100 ( \% )$$

$$Y = \frac{{m}_{initiale} - {m}_{r}}{{m}_{initiale}} \cdot 100 ( \% )$$

$${m}_{r} = C \cdot {M}_{AQwittig} \cdot {V}_{mélange} ( g )$$

The obtained results are indicated in the table below:

Grafted AQ level and gravimetric yield of AQwittig incorporated into the monoliths

| | St-DVB-AQ | St-EGDMA-AQ | St-DEGDMA-AQ |
|---|---|---|---|
| A | 0.521 | 0.819 | 0.689 |
| T_{AQ exp} | 10.58% | 8.77% | 9.22% |
| T_{AQ th} | 10.66% | 8.81% | 9.31% |
| Y | 99.3% | 100% | 99% |

The grafted AQ level (T_{AQ}) on the monoliths is comprised between 8 and 11% of AQ per gram of monolith. The gravimetric yield (Y) of grafted AQwittig, determined by UV, is greater than 99% in the case of the three types of monoliths.

### Example 4: Properties of the Catalysts

1. Thermal Stability of the Catalysts

The thermal stability of the catalysts was tested by thermogravimetric analysis (TGA).

TGA was carried out by means of a Shimadzu apparatus, version TGA-50TA. An amount of about 10 mg of product is laid on a platinum boat and then heated to 500° C., with a gradient of 10° C./min, under a nitrogen atmosphere or an oxidizing atmosphere (air).

This analysis gave the possibility of demonstrating that the monolithic catalysts according to the invention are stable up to 300° C. and that they may therefore be used during cooking.

2. Mechanical Stability of the Catalysts

The mechanical stability of the catalysts according to the invention was tested according to the test described hereafter.

Three-Point Flexure: Mechanical Stability of the Monoliths

The apparatus used is a tensile machine of the MTS QTest25 Elite type with a maximum force of 25 kN. It gives the possibility of calculating the Young modulus by means of a piece of software TestWorks 4. The measurements were carried out on cylindrical samples (radius 10 mm, height 40 mm) with an initial imposed compression rate of 1 mm/min. The length between the supports is equal to 35 mm.

3. Morphology of the Monoliths

The morphology of the monolithic catalysts may be analyzed according to different techniques described hereafter.

Scanning Electron Microscopy (SEM)

The internal structure of the monoliths was viewed with a scanning electron microscope of the JOEL JMS-6700 Field Emission type between 2-5 kV. The dry monoliths were first metallized with a gold layer deposited for 20 seconds with a JOEL-JFC-1200 Fine Coater, in order to facilitate discharge of the electrons at the surface.

Transmission Electron Microscopy (TEM)

Observations with the transmission electron microscope were carried out on an apparatus of the MET CM 10 (FEI) type at 80 kV for observing the internal structure of the monoliths.

Sections of a sample with a thickness of 50 and 75 nm were made on an ultramicrotome, ultracut E (Leica) by means of a diamond knife at the rate of 1 mm/s floating on water. These sections were deposited on copper grids of 600 mesh, with fine hexagonal bars and are observed with the microscope.

In particular, the SEM photographs gave the possibility of ascertaining that the monoliths are porous and homogeneous and that the presence of anthraquinone modifies the size of the grains and of the intergranular empty spaces.

### Example 5: Porosity and Specific Surface Area of the Catalysts

The methods used for measuring these two parameters are described hereafter.

1. Porosimetry by Nitrogen Adsorption: Porosity of the Monoliths (BET)

The specific surface area of the monoliths was measured by nitrogen adsorption at 77K with a Micrometrics ASAP2100 apparatus, by assuming that the surface of a single nitrogen molecule is 16.2 Å. The samples are degassed and dried in vacuo at 120° C. for 24 hours before each measurement.

By tracking the pressure, the number of adsorbed molecules is determined and an adsorption isotherm is obtained which allows calculation of the specific surface area by means of the BET (Brunauer, Emmett, Teller) model based on the analytical calculation of the adsorption isotherms determined experimentally. This method measures the adsorption (multimolecular) and the desorption of nitrogen at the surface of the monolith during its cooling with liquid nitrogen and gives the possibility of inferring the porosity from the isotherms.

For a given temperature, the relationship between the amount of adsorbed gas (by mass or volume) and its pressure is called an adsorption equilibrium isotherm. It expresses thermodynamic equilibrium between the gas phase and the solid phase.

The aspect of the adsorption isotherms gives indications on the characteristics of the material. In the literature, six adsorption isotherm curves are described (Rouquerol, F.; Llewellyn, P.; Rouquerol, J.; Luciani, L.; Denoyel, R. Techniques de l'ingénieur 2003, P1050).
The isotherm of type I is obtained for materials exclusively having micropores which are filled at pressures which are all the lower since their diameter is smaller.
The adsorption isotherm of type II is characteristic of multimolecular adsorption and it is obtained with non-porous or macroporous adsorbents at the surface of which the adsorbed layer gradually thickens.
The adsorption isotherm of type IV is obtained with mesoporous adsorbents wherein a capillary condensation occurs. The desorption of nitrogen condensed by capillarity in the mesopores is not reversible: hysteresis of the desorption is generally observed relatively to the adsorption.
The adsorption isotherms of type III and V are observed in the case of adsorption of steam by a hydrophobic surface. They are much rarer for materials having low adsorbent/adsorbable interactions.
The adsorption isotherm with steps, of the type VI, was observed more recently in the case of adsorption by energetically homogeneous surfaces on which the adsorbed layers form one after the other.

The BET method gives the possibility of determining in the dry condition the total porosity of a monolith: micropores, mesopores and macropores.

2. Porosimetry by Intrusion of Mercury: Porosity of the Monoliths (PIM)

Porosimetry by intrusion of mercury is used for characterizing the distribution of the size of pores and the porosity of macroporous materials. These measurements are conducted on a Micrometrics AutoPore IV 9500 apparatus on samples for which the mass is comprised between 0.4 and 1 g. The volume of non-wetting mercury (the contact angle of the mercury, θ_{Hg}, is generally comprised between 110 and 160° according to the relevant surfaces) penetrates into the pores of the sample (in vacuo) depending on the pressure applied to the mercury.

The diameter of the pore into which the mercury may penetrate is inversely proportional to the applied pressure: the smaller the pores, the more a high pressure is needed (Krajnc, P.; Leber, N.; Stefanec, D.; Kontrec, S.; Podgornik, A. Journal of Chromatography A 2005, 1065, (1), 69-73). The cylindrical pore model and the variation of the intrusion volume according to the pressure give the possibility of calculating the average diameter of the pores.

This technique gives the possibility of only measuring the macropores which cannot be compared with the BET method which also measures small pores (Svec, F.; Frechet, J. M. J. Chemistry of Materials 1995, 7, (4), 707-715).

3. Results

Influence of the presence of AQ with different cross-linking agents on the porosity

| Cross- | | | dₚₒᵣₑₛ | dₚₒᵣₑₛ |
|---|---|---|---|---|
| linking | | Sₛₚ, | PIM¹⁾, | BET²⁾, |
| agent | % AQ | m²/g | nm | nm |
| DVB | 0 | 21 | 265 | — |
| DVB | 10.5 | 134 | 118 | 5 |
| EGDMA | 0 | 113 | ND | 10 |
| EGDMA | 8.8 | 153 | 46 | 6 |
| DEGDMA | 0 | 130 | 46 | 5 |
| DEGDMA | 9.2 | 97 | ND | 4 |

Conditions: M/P = 2/3 (volumetric ratio between the monomers and the pore-forming solvents); 1.5% of AIBN; 24% of St; 16% of Cross-linking agent; 50% Dod; 10% Tol; dₘₒₙₒₗᵢₜₕ = 10 mm,
¹⁾average diameter of the pores by PIM,
²⁾average diameter of the pores by BET.

The obtained results show that the presence of the AQwittig monomer in the hydrophobic monoliths St-DVB-AQ, increases the specific surface area and reduces the diameter of the pores.

In the case of more hydrophilic monoliths, based on EGDMA, the presence of anthraquinone causes an increase in the specific surface area but remains without any consequence on the porosity.

The porosity of the monolith based on DEGDMA is not measurable by the PIM technique due to the absence of penetration of the mercury. This monolith does not have any macroporosity. According to the results obtained by PIM measurement for monoliths based on EGDMA or on DVB, both of these types of monoliths have macropores with additionally mesopores in the case of the monolith based on EGDMA.

### Example 6: Kraft Cooking in the Presence of the Catalysts of the Invention

The cookings are carried out by means of the rotary digester of Smurfit Kappa Cellulose du Pin. The maritime pine unrolling wood, as shavings, is sorted out by means of sieves of different dimensions for using the fractions with a diameter of 7 mm and a thickness of 4 mm. The digester is an autoclave consisting of six shells, which are immersed in an oil bath. In order to determine the amount of required humid wood, the dryness is measured in the oven at 105° C. for 24 hours on 200 g of humid wood. In each shell, are introduced 450 g of wood shavings (expressed in seconds) including 180 g (40%) of a thickness of 4 mm and 270 g (60%) with a diameter of 7 mm. For each cooking, we have three control shells, without any catalyst and three shells in the presence of a catalyst.

The cooking conditions are different according to the value of the targeted kappa number. The example was carried out for a targeted kappa number of 25. The white liquor is sampled in the plant (industrial leaching). The active alkali (total amount of soda and of sodium sulfide expressed in equivalent grams of NaOH and of Na₂O) and the sulfidity (corresponding to the existing sulfur level defined as the ratio between sodium sulfide and the active alkali) are determined by an assay method of the white liquor on two tests. The active alkali level used in cooking varies between 9-22% and the sulfidity between 25-30%. For all the cookings, we kept a same water content. The dilution factor equal to 3.5 represents the ratio between the total amount of water contained in a shell (the sum between the water of the wood, the volume of white liquor and the supply water) and the amount of dry wood.

The digester set into rotation without the shell is preheated to 80° C. At this temperature, are introduced the shells filled with wood, liquor, water and in certain cases with the catalyst. For example, for an alkali of 20%, in a control shell, about 360 g of humid wood with a thickness of 4 mm, 520 g of humid wood of diameter of 7 mm, 770 ml of white liquor of active alkali of 116 g/l of Na₂O and 380 ml of water are introduced.

At the end of the cooking, the shells are suddenly cooled by immersing them in cold water. In the case of shells with monoliths (catalysts), the latter are recovered and kept in the black liquor. For each shell, the shavings are pre-washed for one night, defibrated for 2 minutes, washed and wringed; the paper pulp is obtained at the end of this sequence of operations. The yield is calculated by weighing taking into account the dryness of the pulp over 50 g.

An amount of 50 g of the recovered pulp is diluted in 2.5 L of water and defibrated for 10 minutes. A sheet is made by means of the Noble Wood form with one litre of the diluted suspension. After drying the sheet on the Noble and Wood dryer at 120° C. until constant weight, the dry weight of the sheet is determined by weighing. This then allows calculation of the volume required for sampling one gram of pulp for measuring the kappa number.

In order to determine the kappa number of the pulp which measures the degree of delignification of an unbleached pulp, the following procedure was used. The kappa number is obtained by oxidation of the residual lignin in the presence of a specific volume of potassium permanganate put into contact with the pulp for a determined time. In the presence of lignin, there is consumption of permanganate which has to be located between 20% and 60% of the initial amount. The reaction is blocked by adding a solution of potassium iodide. The released iodine is then assayed by a solution of sodium thiosulfate in an acid medium (ISO 302:2004 standard, Pulps—Determination of Kappa number; 2nd edition ed.; French Standardization Association (Association Française de Normalisation) (AFNOR), 2004).

After having reduced the total volume (pulp+water) to 910 mL, it is placed with stirring and at the same time 40 ml of KMnO₄ 0.6 N and 50 mL of H₂SO₄ 8 N are poured. The stopwatch is triggered after 2 minutes, by means of a thermometer the temperature C is measured. The reaction is left to continue until 5 minutes and it is then stopped by adding 20 ml of KI (160 g/l). The released iodine is titrated by a solution of Na₂S₂O₃ 0.6 N, in the presence of the fibers. A few drops of starch paste are added towards the end of the assay.

The volume V of Na₂S₂O₃ required for discolorizing the solution allows calculation of the kappa number according to the relationship:

Kappa number=(V−V_{white})×6×{1+[(25−C)×0.013]}

wherein V_{white} corresponds to the volume of consumed Na₂S₂O₃ by only using water (without any pulp).

The table hereafter lists all the results of the control cookings and with the monoliths.

| Water/ | | | | | |
|---|---|---|---|---|---|
| Wood = 3.5 | Amount of | | | | |
| Pinus | anthraquinone, | Active | | | |
| Maritima = 450 g | % (relatively | alkali % | Sulfidity | Kappa | Yield |
| t = 140 minutes | to dry wood) | in Na₂O | % | number | % |
| DVB | 0 | 20 | 31 | 27 | 44.8 |
| | 0 | 21 | 31 | 25.2 | 43.5 |
| | 0 | 22 | 31 | 21.3 | 40.9 |
| | 0.2 | 16 | 31 | 37.3 | 46.9 |
| | 0.2 | 18 | 31 | 30.8 | 46.3 |
| | 0.2 | 20 | 31 | 22.5 | 43.9 |
| DVB | 0 | 20 | 30 | 40.1 | 50.1 |
| | 0 | 21 | 30 | 26.7 | 47.7 |
| | 0 | 22 | 30 | 23.7 | 46 |
| | 0.2 | 16 | 30 | 47.4 | 51.4 |
| | 0.2 | 18 | 30 | 34.6 | 49.9 |
| | 0.2 | 20 | 30 | 27.4 | 47.6 |
| DVB | 0 | 20 | 27 | 36.6 | 45.1 |
| | 0 | 21 | 27 | 30.9 | 44.3 |
| | 0 | 22 | 27 | 20.8 | 43 |
| | 0.2 | 16 | 27 | 44.2 | 46 |
| | 0.2 | 18 | 27 | 34.1 | 45.1 |
| | 0.2 | 20 | 27 | 31.2 | 43.7 |
| DVB | 0 | 20 | 29 | 34.7 | 47 |
| | 0 | 21 | 29 | 26.5 | 45.3 |
| | 0 | 22 | 29 | 22.4 | 44.2 |
| | 0.2 | 16 | 29 | 37.4 | 47.3 |
| | 0.2 | 18 | 29 | 32.4 | 46 |
| | 0.2 | 20 | 29 | 27.8 | 44.8 |
| DEGDMA | 0 | 20 | 31 | 29 | 44.8 |
| | 0 | 21 | 31 | 24.7 | 44 |
| | 0 | 22 | 31 | 23.6 | 43.8 |
| | 0.2 | 16 | 31 | 48.9 | 48.5 |
| | 0.2 | 18 | 31 | 32.6 | 46.6 |
| | 0.2 | 20 | 31 | 25.4 | 45.4 |
| DEGDMA | 0 | 18 | 28 | 36.6 | 46.2 |
| | 0 | 20 | 28 | 30.9 | 44.7 |
| | 0 | 22 | 28 | 20.8 | 45.2 |
| | 0.2 | 16 | 28 | 44.2 | 49.8 |
| | 0.2 | 18 | 28 | 34.1 | 47.1 |
| | 0.2 | 20 | 28 | 31.2 | 47 |
| DEGDMA | 0 | 18 | 29 | 40.6 | 48.6 |
| | 0 | 20 | 29 | 30.5 | 46.6 |
| | 0 | 22 | 29 | 25.2 | 45.1 |
| | 0.2 | 16 | 29 | 54.3 | 50.1 |
| | 0.2 | 18 | 29 | 37.9 | 47.1 |
| | 0.2 | 20 | 29 | 29.5 | 45.7 |
| DEGDMA | 0 | 18 | 26 | 35.6 | 46.8 |
| | 0 | 20 | 26 | 31.3 | 44.7 |
| | 0 | 22 | 26 | 27 | 43.9 |
| | 0.4 | 16 | 26 | 42.4 | 47.9 |
| | 0.4 | 18 | 26 | 36.3 | 46.6 |
| | 0.4 | 20 | 26 | 27 | 45 |

This table of results gives the possibility of ascertaining the efficiency of the catalysts of the invention in terms of yield.

The above catalysts (DVB, EGDMA and DEDGMA) have the following characteristics:

| | Sₛₚ | dₚₒᵣₑₛ | | |
|---|---|---|---|---|
| | BET | PIM | AQ/monolith | Monoliths/dry wood |
| | (m²/g) | (nm) | (% by mass) | (% by mass) |
| St-DVB-AQ | 134 | 118 | 10.6 | 1.9 |
| St-EGDMA-AQ | 153 | 46 | 8.8 | 2.3 |
| St-DEGDMA-AQ | 97 | NM | 9.2 | 2.2 |

It was ascertained that the monoliths St-DVB-AQ, St-EGDMA-AQ and St-DEGDMA-AQ are resistant under the cooking conditions and are not degraded.

### Example 7: Recycling of the Catalysts

### Example 7.1

The monoliths are entirely recovered and without any losses during a first cooking and are again tested during a second cooking. Between two cookings, the monoliths are kept in the black liquor and are used without any purification step. The black liquor allows them to be kept in the same swelling and hydration condition that at the end of cooking.

The obtained results are indicated in the table hereafter (same conditions as in Example 6).

| Water/ | | | | | |
|---|---|---|---|---|---|
| Wood = 3.5 | Amount of | | | | |
| Pinus | anthraquinone, | Active | | | |
| Maritima = 450 g | % (relatively | alkali % | Sulfidity | Kappa | Yield |
| t = 140 minutes | to dry wood) | in Na₂O | % | number | % |
| Recycled DVB | 0 | 20 | 31 | 25.5 | 45.6 |
| | 0 | 21 | 31 | 23.4 | 43.9 |
| | 0 | 22 | 31 | 23.4 | 43.7 |
| | 0.2 | 16 | 31 | 47.4 | 47.9 |
| | 0.2 | 18 | 31 | 33.3 | 46 |
| | 0.2 | 20 | 31 | 24.6 | 44.7 |
| Recycled DVB | 0 | 18 | 30 | 33.9 | 45 |
| | 0 | 20 | 30 | 31.4 | 44.5 |
| | 0 | 22 | 30 | 22.2 | 44 |
| | 0.2 | 16 | 30 | 44.9 | 47.9 |
| | 0.2 | 18 | 30 | 33.2 | 46.1 |
| | 0.2 | 20 | 30 | 27.1 | 45 |
| Recycled DVB | 0 | 18 | 30 | 36.8 | 47.3 |
| | 0 | 20 | 30 | 31.7 | 45.9 |
| | 0 | 22 | 30 | 26.4 | 44.4 |
| | 0.2 | 16 | 30 | 44.4 | 48.7 |
| | 0.2 | 18 | 30 | 36.1 | 47.2 |
| | 0.2 | 20 | 30 | 30.7 | 45.3 |
| Recycled | 0 | 18 | 30 | 40.9 | 46.7 |
| DEGDMA | 0 | 20 | 30 | 29.8 | 45 |
| | 0 | 22 | 30 | 26.7 | 44.1 |
| | 0.2 | 16 | 30 | 49.2 | 47.6 |
| | 0.2 | 18 | 30 | 38.7 | 46.6 |
| | 0.2 | 20 | 30 | 27.1 | 45.4 |

This table of results gives the possibility of ascertaining the efficiency of the catalysts according to the invention, once they are recycled.

### Example 7.2.—Study of the Time-Dependent Change of the Kappa Number Values Versus the Number of Cookings by Recycling the Same Monoliths

The Kappa number which takes into account the residual lignin level on the fibers (the lower it is, the more delignification has been performing) was measured on classified pulps. This classification consists of separating the fibers from the uncooked.

The measurement of the classified Kappa number corresponds to the measurement of the Kappa number at the output of the method, while doing without the uncooked.

TABLE 1
The Classified Kappa Number ([IK]_{c}) depending on
the number of recyclings of the monoliths for an active
alkali of 22% relatively to the controlled cookings.

| Number | [IK]_{c} | [IK]_{c} | delta |
|---|---|---|---|
| of uses | Control | Catalyst | [IK] |
| 1 | 58.9 | 58.7 | 0.2 |
| 2 | 72.3 | 65.6 | 6.7 |
| 3 | 72.5 | 67.0 | 5.5 |

At a weight content of active alkali of 22%, the effect on the Kappa number is retained after 3 cookings in spite of the sources of variation related to the method. No physical degradations of the monoliths were observed.

TABLE 2
The Classified Kappa Number according to the number
of recyclings of the monoliths for an active alkali
of 26% relatively to the control cookings.

| Number | [IK]_{c} | [IK]_{c} | delta |
|---|---|---|---|
| of uses | Control | Catalyst | [IK] |
| 1 | 44.6 | 44.3 | 0.3 |
| 2 | 49.4 | 45.8 | 3.6 |
| 3 | 57.0 | 54.9 | 2.1 |
| 4 | 60.2 | 54.9 | 5.3 |
| 5 | 60.2 | 54.9 | 5.3 |

The first two cookings were achieved with a batch of wood different from the three last ones.

In spite of this, for a weight content of active alkali of 26%, the effect on the Kappa number is retained after 5 cookings, and this in spite of the variation sources related to the method. No physical degradations of the monoliths were observed.

All these results demonstrate the efficiency of the monolithic catalysts according to the invention, and this even after several uses.

1. A supported anthraquinonic catalyst as a monolith, comprising a polymeric support containing at the surface at least one anthraquinone unit, said supported anthraquinonic catalyst being able to be obtained by radical polymerization of a reaction mixture comprising:
styrene;
at least one initiator generating free radicals;
at least one cross-linking agent which is at least difunctional, selected from the group consisting of: divinylbenzene, ethylene glycol dimethacrylate, di(ethylene glycol) dimethacrylate, compounds comprising an alkyl chain, interrupted by one or several groups —((CH₂)ₖO)ₘ with 2≦k≦5, 1≦m≦3, substituted in an α or ω position with at least one acrylate, methacrylate, vinyl or styrenic function, and mixtures thereof;
at least one pore-forming agent; and
at least one anthraquinonic styrenic monomer of formula (I) 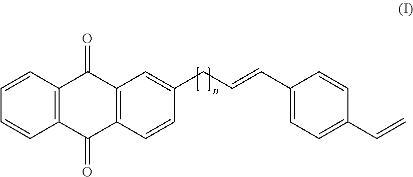
wherein n is an integer varying from 1 to 5.

2. The supported anthraquinonic catalyst according to claim 1, wherein the pore-forming agent is selected from the group consisting of toluene, long chain alcohols comprising at least 10 carbon atoms, long chain alkanes comprising at least 10 carbon atoms, ethylene glycol oligomers and mixtures thereof.

3. The supported anthraquinonic catalyst according to claim 1, wherein the pore-forming agent is a mixture of at least two compounds selected from the group consisting of toluene, long chain alcohols comprising at least 10 carbon atoms and long chain alkanes comprising at least 10 carbon atoms.

4. The supported anthraquinonic catalyst according to claim 1, wherein the pore-forming agent is a mixture of dodecanol and toluene.

5. The supported anthraquinonic catalyst according to claim 1, comprising from 5% to 20% by weight of anthraquinone based on the total weight of the supported anthraquinone catalyst.

6. The supported anthraquinonic catalyst according to claim 1, wherein the reaction mixture comprises:
from 10% to 30% by weight of styrene based on the total weight of reaction mixture;
from 0.1% to 5% by weight of initiator based on the total weight of reaction mixture;
from 10% to 30% by weight of a cross-linking agent based on the total weight of reaction mixture;
from 10% to 60% by weight of a pore-forming agent based on the total weight of reaction mixture; and
less than 10% by weight of an anthraquinonic styrenic monomer of formula (I).

7. The supported anthraquinonic catalyst according to claim 1, for which the specific surface area determined by the BET method is greater than or equal to 20 m²/g.

8. The supported anthraquinonic catalyst according to claim 1, for which Young's modulus is comprised between 100 MPa and 400 MPa.

9. A method for catalyzing the kraft or alkaline cooking of the wood, comprising contacting wood with the supported anthraquinonic catalyst according to claim 1.

10. A method for preparing a supported anthraquinonic catalyst, as a monolith, according to claim 1, by radical polymerization of a reaction mixture comprising:
styrene;
at least one initiator generating free radicals;
at least one cross-linking agent which is at least difunctional, selected from the group consisting of: divinylbenzene, ethylene glycol dimethacrylate, di(ethylene glycol) dimethacrylate, compounds comprising an alkyl chain, interrupted with one or several groups —((CH₂)ₖO)ₘ with 2≦k≦5, 1≦m≦3, substituted in the α or ω position with at least one acrylate, methacrylate, vinyl or styrenic function, and mixtures thereof;
at least one pore-forming agent; and
at least one anthraquinonic styrenic monomer of formula (I) 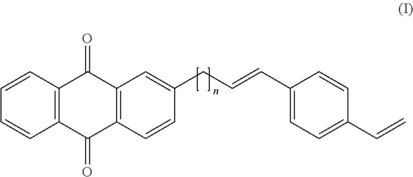
wherein n is an integer varying from 1 to 5.

11. A method for preparing a cellulosic pulp, comprising a kraft or alkaline cooking step of wood shavings or of lignocellulosic biomass at a temperature comprised between 130° C. and 180° C. for a period from 30 minutes to 120 minutes, in the presence of water, of supported anthraquinonic catalyst according to claim 1, and of an aqueous solution of soda and/or sodium sulfide.
